(19) United States
(12) Patent Application Publication
(10) Pub. No.: US 2002/0194679 A1
(43) Pub. Date: Dec. 26, 2002

(54) Pliers with bicycle tools

(76) Inventor: Eric H. Hawkins, Lake Elmo, MN (US)

Correspondence Address: BRIGGS AND MORGAN, P.A., 2400 IDS CENTER, MINNEAPOLIS, MN, 55402, US

(21) Appl. No.: 09/887,179

(22) Filed: Jun. 22, 2001

(51) Int. Cl. B25B 7/22

(52) U.S. Cl. 7/128

(57) ABSTRACT

A folding multi-tool has a pair of channel-shaped handles, each of which is generally “C”-shaped in cross-section. A plier half pivots into and out of each of the handles, forming a plier which has a large pivot pin acting as a pivot axle to the plier halves. A number of tools are also pivotable into and out of the handles, especially including a bicycle spoke wrench and a bicycle chain tool.

### BACKGROUND OF THE INVENTION

The present invention relates generally to a multi-function pocket tool which includes adjustable pliers and other selected tools, and in particular tools for bicycle maintenance and repair.

Multi-function tools are well known. In typical multi-function tools, pliers and other selected tools, such as screwdrivers, knife blades, files, etc. are provided in a single tool. Known multi-function tools often include pliers and have channel-shaped handles pivotally connected to the tangs of the pliers. The handles fold over so that the pliers are received in the channel-shaped handles. Also, the other tools fold over and are received in the channel-shaped handles.

Examples of issued patents that disclose folding multi-function tools are U.S. Pat. No. 4,744,272 and 6,047,426, herein incorporated by reference.

Tool assemblies containing a number of tools for bicycle repair are also known, as exemplified by U.S. Pat. No. 6,112,351, herein incorporated by reference.

There is a need for a folding multi-function tool with pliers and bicycle maintenance and repair tools.

### SUMMARY OF THE INVENTION

A folding multi-tool has a pair of channel-shaped handles, each of which is generally “C”-shaped in cross-section. A plier half pivots into and out of each of the handles, forming a plier which has a large pivot pin acting as a pivot axle to the plier halves. A number of tools are also pivotable into and out of the handles, especially including a bicycle spoke wrench and a bicycle chain tool.

### BRIEF DESCRIPTION OF THE DRAWINGS

FIG. 1 is a plan view of the tool of the present invention in the closed configuration.

FIG. 2 is a side elevational view of the tool of the present invention in the closed configuration.

FIG. 3 is a plan view of the tool of the present invention in a partially opened configuration.

FIG. 4 is a plan view of the tool of the present invention in a fully opened configuration.

FIG. 5 is a detailed partial plan view of the tool of the present invention with bicycle maintenance tools deployed.

FIG. 6 is a partial plan view of the tool of the present invention with all tools deployed.

### DETAILED DESCRIPTION OF THE PREFERRED EMBODIMENT

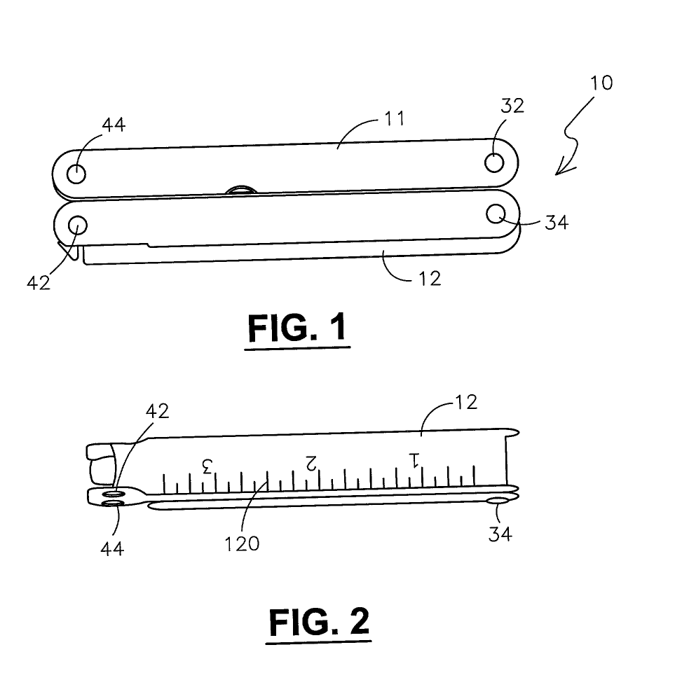

Referring now to the drawing figures, wherein like reference numerals represent like parts throughout the several views, FIG. 1 shows a folding multi-tool 10 according to a preferred form of the invention. The folding multi-tool 10 depicted in FIG. 1 is shown in a closed, compact configuration, such as would be used for storing the tool in a sheath. The folding multi-tool 10 includes first and second channel-shaped handles 11 and 12.

Each of the channel-shaped handles 11, 12 is generally “C”-shaped in cross-section, as is shown in the patents incorporated by reference.

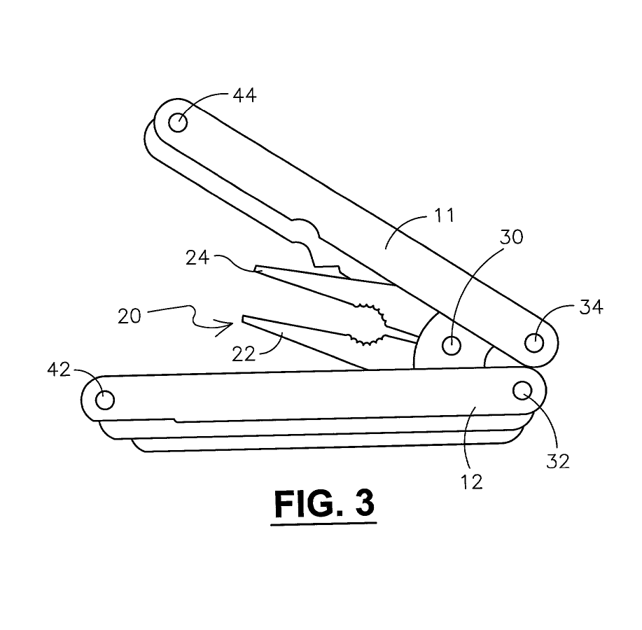

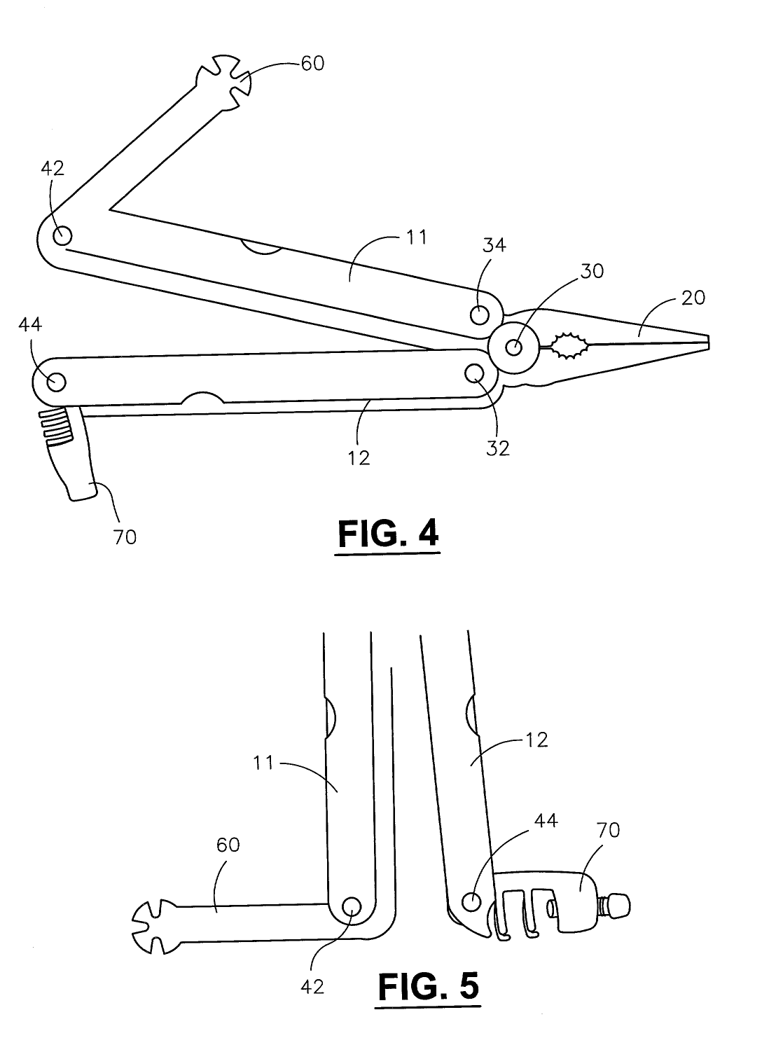

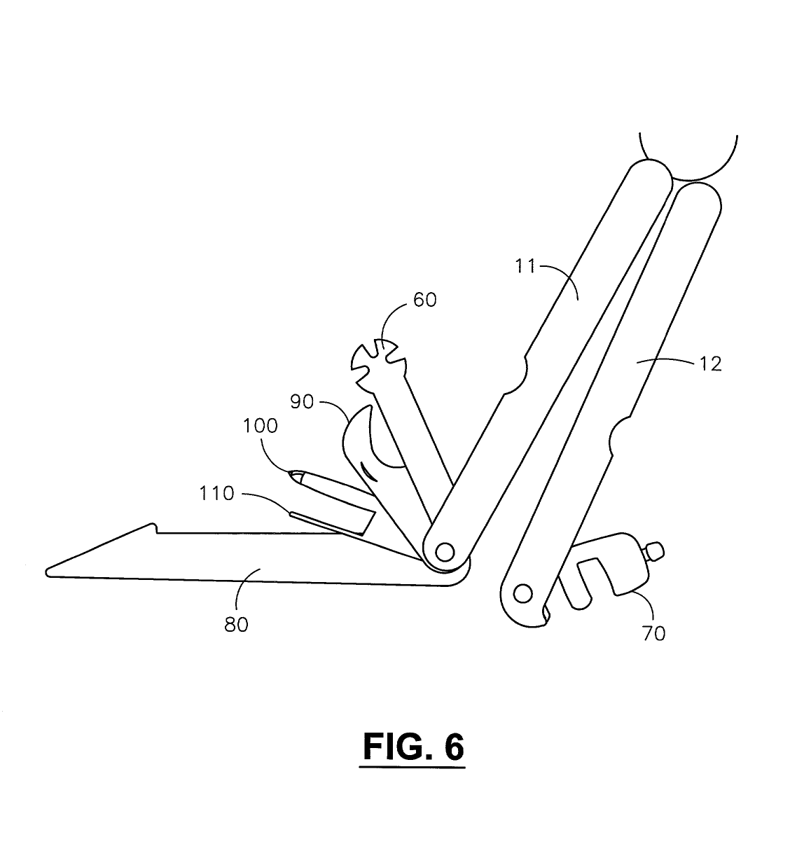

The folding multi-tool 10 includes pliers 20 having a first plier half 22 and a second plier half 24 (see FIG. 3). A large pivot pin 30 acts as a pivot axle to allow the first and second pier halves 22 and 24 to be pivoted relative to each other. One plier half 22 pivots into the handle 11, and the second plier half 24 pivots into the handle 12, as shown in the patents incorporated by reference. The plier halves 22, 24 are secured to the handles 11, 12 by bolt/pivot pins 32, 34.

At the end of the handles 11 and 12 opposite the bolt/pivot pins 32, 34, a second pair of combination bolt/pivot pins 42, 44 is provided. These bolt/pivot pins extend through the handles 11, 12 and through numerous individual tools received in the channel-shaped handles.

A number of tools are pivotally received in the open sides of the handles 11, 12 and are pivoted about the pivot pins 42, 44. Of particular relevance to the present invention are a spoke wrench 60 and a bicycle chain tool 70. Other tools that may be included comprise, but are not limited to, a large knife blade 80, small knife blade 90, Phillips screwdriver 100, and awl 110.

One of the sides 11, 12 may have a scale 120 engraved thereon.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A folding multi-tool, comprising:
a) a pliers;
b) a spoke wrench; and
c) a bicycle chain tool.

2. The folding multi-tool of claim 1, further comprising a pair of channel-shaped handles, and wherein the pliers, the spoke wrench, and the bicycle chain tool pivot into one of the channel-shaped handles.

3. The folding multi-tool of claim 2, wherein the pliers further comprises a first plier half, a second plier half, and a pivot pin engaging the first plier half and the second plier half.

4. The folding multi-tool of claim 3, wherein the first plier half pivots into one of the channel-shaped handles and the second plier half pivots into the other channel-shaped handle.

5. The folding multi-tool of claim 1, further comprising an engraved scale thereon.

6. A folding multi-tool, comprising:
a) a pair of channel-shaped handles;
b) a pliers;
c) a spoke wrench; and
d) a bicycle chain tool,
wherein the pliers, the spoke wrench, and the bicycle chain tool pivot into the channel-shaped handles.

7. The folding multi-tool of claim 6, wherein the pliers further comprises a first plier half, a second plier half, and a pivot pin engaging the first plier half and the second plier half.

8. The folding multi-tool of claim 7, wherein the first plier half pivots into one of the channel-shaped handles and the second plier half pivots into the other channel-shaped handle.

9. The folding multi-tool of claim 6, further comprising an engraved scale thereon.

10. A folding multi-tool, comprising:
a) a pair of channel-shaped handles;
b) a pliers further comprising a first plier half, a second plier half, and a pivot pin engaging the first plier half and the second plier half;
c) a spoke wrench; and
d) a bicycle chain tool,
wherein the pliers, the spoke wrench, and the bicycle chain tool pivot into the channel-shaped handles, wherein the first plier half pivots into one of the channel-shaped handles and the second plier half pivots into the other channel-shaped handle.

11. The folding multi-tool of claim 6, further comprising an engraved scale thereon.
